(19) United States
(12) Patent Application Publication
(10) Pub. No.: US 2024/0417825 A1
(43) Pub. Date: Dec. 19, 2024

(54) PROCESS FOR CONCENTRATING LITHIUM AND POTASSIUM FROM CLAYS FROM SALT FLATS

(71) Applicant: HOT SPRING MINING, S.A. DE C.V., Guadalupe, Zacatecas (MX)

(72) Inventor: Roberto PÉREZ GARIBAY, Saltillo (MX)

(73) Assignee: HOT SPRING MINING, S.A. DE C.V., Guadalupe, Zacatecas (MX)

(21) Appl. No.: 18/698,560

(22) PCT Filed: Oct. 4, 2022
(86) PCT No.: PCT/IB2022/059473

§ 371 Date: Apr. 4, 2024

(30) Foreign Application Priority Data
Apr. 10, 2021 (MX) MX/A/2021/012211

(51) Int. Cl. C22B 26/12; C01D 1/32; C01D 15/00; C22B 1/24; C22B 3/02; C22B 3/04; C22B 3/38; C25C 1/02

(52) U.S. Cl. CPC C22B 26/12; C01D 1/32; C01D 15/00; C22B 1/24; C22B 3/02; C22B 3/04; C22B 3/3846; C25C 1/02; C01P 2002/70

(57) ABSTRACT

The present invention is related to the production and concentration of lithium and potassium from natural sources, in particular from clays from salt flats.

### FIELD OF THE INVENTION

The present invention is related to the production and concentration of lithium and potassium from natural sources, in particular from clays from salt flats.

### BACKGROUND

In the state of the art there are various processes of obtaining and concentration of lithium and potassium, however, there is a need for a process to obtain and/or isolate said lithium and potassium metals in the most sustainable and economically possible way, which is achieved by reproducing the present invention.

Document WO2017096495A1, describes an electrolytic sequential process and system to increase the concentration of lithium present in natural brines that replaces wells or evaporation pools avoiding water loss.

Document CA3036143A1, discloses a method for extracting lithium from brine, comprising the stages of: providing a lithium-containing brine; processing brine to remove contaminants; subjecting brine to physical lithium extraction; disposing of lithium-depleted brine; add water to the extracted lithium to create a lithium solution; perform a concentration of the lithium solution; expose the lithium solution to crystallization and evaporation; and recover the resulting lithium salt.

Document US20150197830A1, describes a method for extracting lithium from a solution comprising the stages of: separating the solution that includes lithium into a solution containing monovalent ions, using a separation membrane that has a negative charge on its surface; removing impurities from the solution containing value metal ions; and precipitate the dissolved lithium in the solution, adding a material that supplies phosphorus to the solution containing the value ions.

One of the differences that exists in the process described herein with respect to the processes disclosed in the state of the art, is that the present process does not start from a brine with dissolved lithium and potassium, but from muscovite and sanidine clays rich in these elements. Until now, the acid leaching of clays by water decomposition has not been published in scientific articles or in patent documents.

Muscovite and sanidine clays rich in potassium and lithium can contain a fraction of these elements in their crystalline structure and the other fraction as salts impregnated on the particles. The fraction of potassium chloride and lithium salts impregnated in clays when mixed with water may form a brine similar to most brines that have been studied in some scientific articles, or are used according to patent documents, however, the other fraction of potassium and lithium found within the crystalline structure of clays can only be extracted by leaching methods, and it is here where the protonic charge leaching method of the present invention represents a solution, in addition to presenting other advantages of sustainability and low cost.

It is worth mentioning that in all methods of extraction of lithium from known clays, acid leaching is used by adding hazardous, highly corrosive and polluting chemical reagents (as described in document WO2019190301A1 and scientific literature paper MESHRAM P. et al—Hydrometallurgy, 150, (2014), pp. 192-208). However, with the method proposed herein, acid leaching is carried out without the use of these chemical reagents since the acid medium is generated using only water. The fraction of potassium and lithium found within the crystalline structure of clays can dissolve, in the acid medium that is naturally created in the hydrogen proton leaching reactor.

Another difference of the process of the present invention with others that employ acid leaching is that clays can be easily separated from the aqueous suspension, since exhausted or depleted particles of the elements of interest are clustered and mechanical scraping will suffice to remove and empty them in a waste clay silo. It should be mentioned that, irrespective of whether the brine formed by mixing clays with water or whether the leaching liqueur is similar to those already studied, the main problem with these muscovite and sanidine clays is the technical difficulty in separating them from water. However, with the proposed method this separation is possible because the surface electrical charge of the clays is neutralized by adsorption of hydrogen protons, facilitating flocculation and precipitation of agglomerates. This new process of separation of exhausted clays proposed in the present invention solves an important technological problem, since it was almost impossible to use filters, to separate clays with sizes less than 5 micrometers. This is an additional and important advantage of the process of the present invention.

No physical design and operation of the leaching reactor proposed here to complete the first stage of leaching-concentration and continuous separation of depleted clays has been published in the state of the art, by neutralizing its surface electrical charge. It is worth mentioning that the leaching reactor of the present invention is specially designed to facilitate the process of leaching-concentration and separation of solids. This reactor consists of a cubic cell, which forms the protonic section that facilitates the neutralization of surface charges of the clays and a small alkaline cell with permeable walls to Li and K, wherein these are concentrated.

There are several scientific articles and some patents that study or apply solvent extraction to separate lithium from sodium, calcium and magnesium, among others (SONG Y. et al—Separation and Purification Technology, 229, (2019), 115823). But there are currently no publications or patent documents that talk about using the method to work with aqueous solutions with lithium and potassium, simultaneously.

Currently, the inventors of the present invention have not seen published a global process, to process clays and obtain products of high added value, consisting of the following sub-processes: a) leaching-concentration and separation of solids, b) enrichment of liquors by solvent extraction, c) selective precipitation of lithium and potassium by phosphatizing reactions to obtain lithium phosphate.

### BRIEF DESCRIPTION OF THE INVENTION

In summary, the invention consists of a complete process to extract the lithium (Li) and potassium (K) contained in clay salt flats with muscovite and sanidine, by means of an acid leaching process using hydrogen protons generated in situ with a leaching reactor. Subsequently, the leachate liqueur, diluted in the elements of interest, goes through a solvent extraction process with an organic extracting reagent, preferably DEHPA (di-(2-ethylhexyl)phosphoric acid) in order to concentrate even more the lithium and potassium. In a last stage the concentrated liquor passes to a precipitation with sodium triphosphate to produce lithium phosphate.

### BRIEF DESCRIPTION OF THE DRAWINGS

FIG. 1 illustrates an X-ray diffractogram of the clays head.

FIG. 2 illustrates the flowchart of the process of the present invention.

FIG. 3a is a scheme of the reactor with all its components installed.

FIG. 3b illustrates two titanium plates and one stainless steel plate that are the reactor electrodes of the present invention.

FIG. 3c represents the outer box of the reactor of the present invention.

FIG. 3d illustrates the bag or cation-permeable membrane.

FIG. 3e illustrates two boxes with permeable grids. The box with subinterior grids and the box with interior grids.

FIG. 3f represents a scheme with the outer box and the grids installed inside it in the central position in the reactor of the present invention.

FIG. 4a is a scheme of the cell or reactor in perspective.

FIG. 4b illustrates the installation of the different components that make up the cell or reactor of the present invention.

FIG. 5a shows the kinetics of lithium leaching.

FIG. 5b shows the kinetic of potassium leaching.

FIG. 6 illustrates the electrical conductivity of the alkaline or concentrated solution.

FIG. 7a is a micrograph of clays before leaching.

FIG. 7b is a micrograph of clays after leaching.

FIG. 8a is a diagram of the distribution coefficients of lithium and potassium in the organic and aqueous phase, using DEHPA as an extractant.

FIG. 8b is a diagram of the distribution coefficients of lithium and potassium in the organic and aqueous phase, using CYANEX 272 as an extractant.

FIG. 8c is a diagram of the distribution coefficients of lithium and potassium in the organic and aqueous phase, using P507 as an extractant.

FIG. 9a shows a micrograph of KCIO₄ crystals.

FIG. 9b shows an X-ray diffraction spectrum and an EDS spectrum of KCIO₄.

FIG. 10a shows a micrograph of Li₃PO₄ crystals.

FIG. 10b shows an X-ray diffraction spectrum of Li₃PO₄.

### DETAILED DESCRIPTION OF THE INVENTION

This process is designed to leach and concentrate lithium and potassium from clays rich in these elements, in addition to obtaining high added value products from these metalloids. The process consists of mixing the clay with water until forming a fluid sludge, then passing it through a sieve, in order to remove rocks and leave only small particles. Subsequently, this sludge with small particles should be intensely mixed to disperse and leave all particles free as possible. The process that follows is the leaching of lithium and potassium, and the simultaneous agglomeration-separation of depleted particles, by neutralizing their surface electrical charge. To perform this leaching-agglomeration-separation process, the fluid sludge will be poured into a section of the reactor fitted with a lithium permeable interfacial attachment.

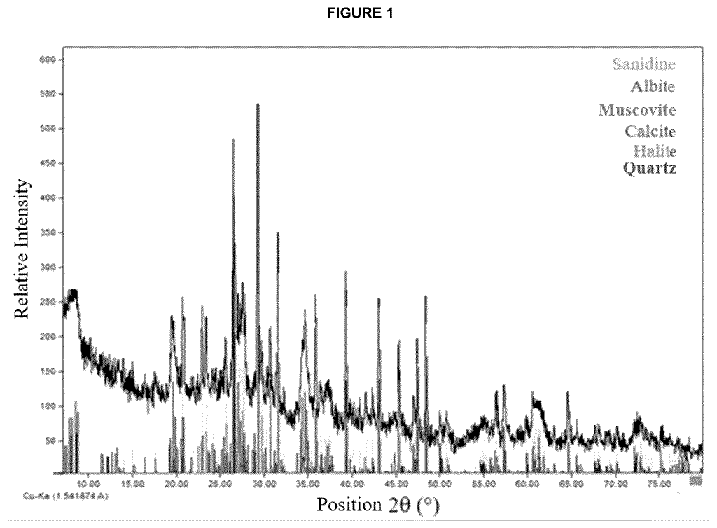

FIG. 1 presents an X-ray diffractogram in which it can be observed that clays head, before leaching, contain the minerals: sanidine, albite, muscovite, calcite, halite and quartz. On the other hand, Table 1 shows the chemical composition of the clays used in the present invention, after performing a chemical analysis by X-ray fluorescence (XRF), the percentages in total weight of the sample of the main elements contained in these clays are shown, with the exception of lithium whose value is expressed in milligrams per liter.

TABLE 1
Chemical composition of clays

| Element | Percentage % | Element | Percentage % |
|---|---|---|---|
| Si | 21.89 | Sr | 0.28 |
| Ca | 13.69 | Br | 0.11 |
| K | 7.8. | V₂ | 0.07 |
| Al | 6.28 | Mn | 0.06 |
| Fe | 5.67 | Ba | 0.05 |
| Mg | 4.23 | P | 0.04 |
| Na | 4.54 | Li *(AA) | 0.025 |
| Cl | 2.55 | Zr | 0.03. |
| Ti | 0.44 | Cr | 0.02 |
| S | 0.57 | Zn | 0.02 |
| | | PPI | 31.62 |

*AA = Atomic Absorption Spectroscopy

The reactor employed in the present invention is specially designed to facilitate the batch leaching-concentration and solids separation process. This reactor consists of a cubic cell of fiberglass or PVC, which contains subsections to generate hydrogen protons that allow leaching.

By employing the process of the present invention, the technical problem of extracting lithium and potassium from salt clays is solved, using a series of sustainable and economic processes.

The method basically consists of starting the stirring in the reactor, starting the leaching by closing the electrical circuit between the titanium and steel plates and after a certain time of operation, the lithium, potassium and sodium will be extracted or leached, leaving the clays depleted in lithium; at that time the surface load of the clays will have been neutralized and the particles naturally agglomerated, so they will have to be extracted. Once the depleted particles have been extracted, fresh clay pulp should be fed to continue the extraction process and continue concentrating lithium and potassium. It is important to mention that the extracted liquor will remain for several days in the reactor, in order to obtain a concentrated liqueur of lithium, potassium and sodium at a pH greater than 13.

Once the concentrated liquor is removed from the reactor, this will go into a physical-chemical process of solvent extraction and stripping. The objective of this stage is to further concentrate the liquor with the lithium and potassium ions. The process consists of turbulently mixing this liqueur with an organic mixture of extractant and solvent so that all lithium and potassium ions pass into the organic mixture. This mixture is then washed with a small volume (as small as possible) of an aqueous solution with hydrochloric acid, so that all lithium and potassium remain in very high concentration in the new liquor ([Li] greater than 4,000 mg/L).

The extractant used in the organic mixture of the present invention can be selected from any of the extractants known in the art, preferably, the extractant used can be selected from di-(2-ethylhexyl)phosphoric acid (DEHPA), 2-ethylhexyl-phosphinic acid (P507), bis(2,4,4-trimethylpentyl)phosphinic acid (CYANEX 272) and/or (2-ethylhexyl)phosphonic acid mono-2-ethylhexyl ester (PC88A), most preferably the extractant used is di-(2-ethylhexyl)phosphoric acid (DEHPA). On the other hand, the solvent used in the organic mixture of the present invention can be selected from any of the solvents known in the art, preferably, the solvent used can be selected from kerosene and/or tributyphosphate (TBP).

The concentrated liquor will then go to a chemical process, in which it will be sought to precipitate the elements of value (Li). To do this, the concentrated liquor will be poured into a conical bottom reactor, to which a phosphate reagent will be added and as a result the lithium will be precipitated, which will be removed like a white sludge.

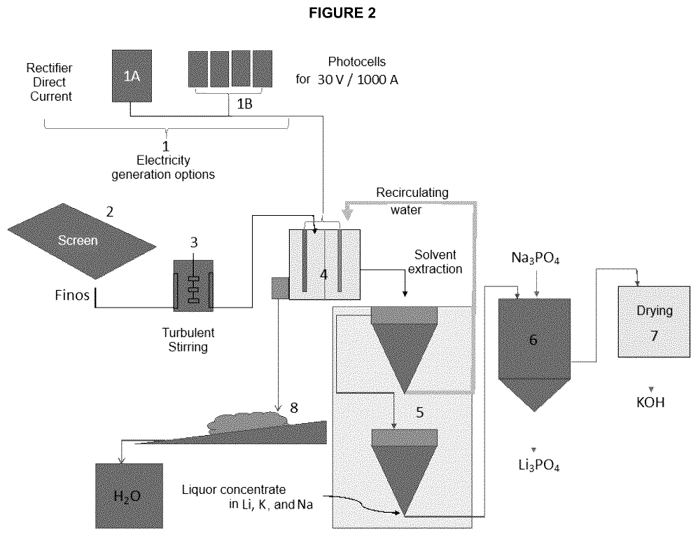

FIG. 2 represents a flow diagram of the entire process, which is described below: section (1) represents the source of electrical power that may have two options for eventual use in a pilot or industrial plant, namely: rectifier that converts the alternating current to direct current (1A) and the power generation plant of direct current by means of solar panels or photocells (1B). Preferably the photocells can supply at least 30 Volts (V) and 1,000 Amps (A). As a whole the section (1) must be able to supply at least 4 A with a variable voltage.

Section (2) indicates the presence of a screening sub-process, by which rocks larger than mesh size #5 (US standard sieve) are separated.

Section (3) represents a battery of turbulent stirring mixers to disintegrate clay agglomerates.

Section (4) symbolizes the reactor plant or extraction and leaching cell by electrochemical process.

Section (5) represents the solvent extraction and stripping plant, through which the liquor with very high lithium and potassium concentration is produced.

Section (6) symbolizes the plant of lithium precipitates in the form of lithium phosphate (Li₃PO₄), adding phosphoric acid (H₃PO₄) or sodium phosphate (NA₃PO₄). While the section (7) represents the drying yards of the liquor to obtain potassium hydroxide.

Section (8) represents the waste yards or silos where clays depleted in lithium and potassium accumulate.

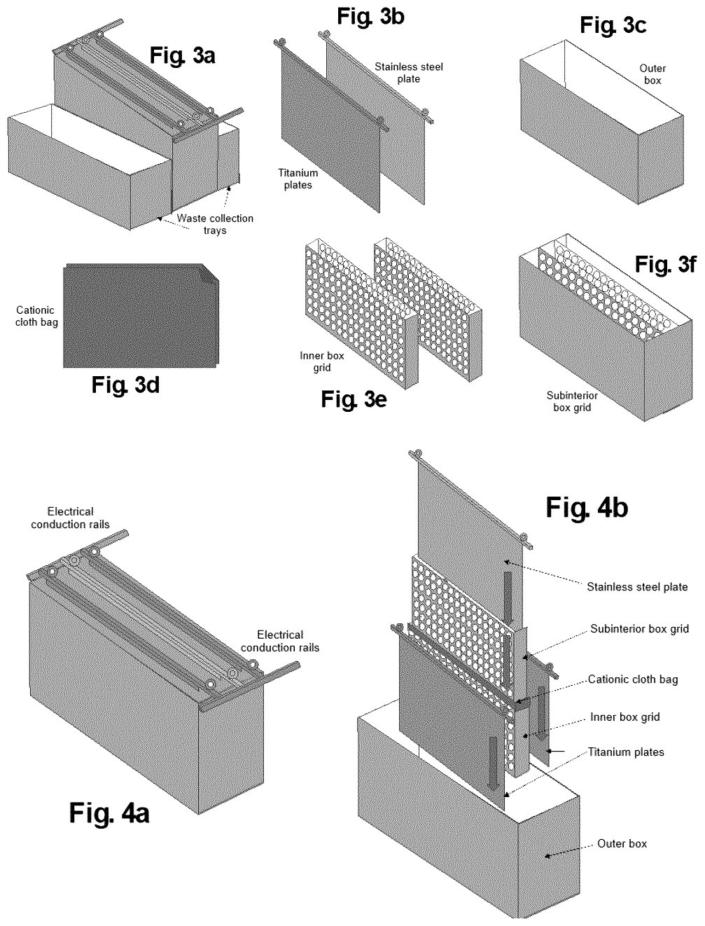

The leaching reactor of the present invention is composed of several components which are schematically represented in FIGS. 3a to 3f. Specifically, FIG. 3a is a scheme of the reactor with all its components installed (including side trays for waste collection). FIG. 3b illustrates two titanium plates and one stainless steel plate that are the reactor electrodes of the present invention. FIG. 3c represents the outer box of the reactor of the present invention, said outer box is made of PVC or fiberglass. FIG. 3d illustrates the cloth bag or membrane of some similar material that is permeable to cations. FIG. 3e illustrates two boxes with grids made of permeable PVC or fiberglass; the smaller one (box with subinterior grids) is placed inside the larger one (box with inner grids) and between them is placed the bag or membrane permeable to the cations of interest. FIG. 3f represents a scheme with the inner box and the permeable grids installed inside it in the central position in the reactor of the present invention.

In one embodiment the dimensions of titanium and steel plates are 23.5 cm high, 26 cm long and 0.5 cm thick; while the dimensions of the outer box are 25 cm high, 30 cm long and 21 cm wide; the dimensions of the cationic bag or membrane are 25 cm high and 29 cm long; on the other hand the dimensions of the inner grid box are 25 cm high, 29 cm long and 9 cm wide; while the dimensions of the box with subinterior grids are 25 cm high, 28 cm long and 7.5 cm wide. All quantities of this embodiment can be scaled proportionally to cover other embodiments of the present invention.

FIGS. 3a-3f and FIGS. 4a and 4b, as a whole, try to guide the sequential installation of each of the reactor or cell components of the present invention. In this way, FIG. 4a represents a scheme of the cell or reactor in perspective, wherein are also illustrated the electrical conduction rails where the electrodes of the reactor or cell of the present invention will be connected. FIG. 4b shows the installation of the different components that make up the cell or reactor of the present invention.

It is important to mention that the width of the outer box is divided into three parts, and in the central zone the two grid boxes are placed, inserting the cationic bag inside the larger grid box and inside the bag of the smaller grid box to accommodate the stainless steel metal plate.

After placing the components of the alkaline area in the central part of the outer cell, a PVC or fiberglass lid is placed in the alkaline area to protect it from any possible contamination with clays. Each titanium plate has two rings so that they are periodically extracted and cleaned from the layer of leachate clays.

The cleaning of these plates should be done with plastic spatulas to prevent such plates from scratching. It is also important to mention that, at the lateral ends, trays should be placed to collect the leachate clays, or waste, to later lead them by a diaphragm pump to the waste silo.

The present invention includes the following embodiments:
1. A process for leaching and concentrating lithium and potassium from clays from salt flats, comprising the stages of:
a) mixing the clays with pure water and sieving to remove stones and large particles;
b) turbulently stirring with a blade mixer the fluid or pulp resulting from stage a) to release small particles;
c) pouring a portion of the fluid obtained in stage b) into the protonic section of a leaching reactor and adding pure water into the alkaline section of the reactor in a 2:1 ratio by volume;
d) initiating the leaching process at the reactor;
e) removing the wet agglomerates resulting from the protonic section and recharge the protonic section with a volume equivalent to the removed volume of wet agglomerates, in order to replace the exhausted clays extracted from the reactor;
f) repeating the operation of stage e), until full consumption of the fluid or pulp of stage b), to obtain an aqueous leachate liquor accumulated in the alkaline section of the reactor;
g) subjecting the leachate liqueur obtained in stage f) to at least one solvent extraction process comprising turbulently mixing the liqueur obtained in stage f) as an aqueous phase with an organic extractant as an organic phase, in a 1:1 ratio by volume;
h) separating the organic phase from the mixture obtained in stage g) and mixing the organic phase with an aqueous solution with hydrochloric acid in a ratio of 3:1, respectively, to obtain a liqueur with a high concentration of lithium and potassium;
i) exhausted aqueous liqueurs from stage h) are recirculated back to the extraction process from stage g) to enrich them with lithium and potassium and be fed back to the extraction and stripping process;
j) liquor concentrated in lithium and potassium obtained in stage h) is passed to a precipitation stage, wherein the precipitation stage consists of adding sodium phosphate to the concentrated liqueur obtained in stage h) to obtain precipitated lithium phosphate;
k) the remaining liquor of stage j) is subjected to a drying process to obtain potassium hydroxide.

2. The process according to embodiment 1, wherein in stage d) it is carried out for at least 30 minutes.

3. The process according to embodiment 1, wherein in step f) is repeated for at least 36 hours.

4. The process according to embodiment 1, wherein the accumulated aqueous leachate liquor obtained in stage f), has a pH of at least 13 and an electrical conductivity of at least 45 mS/cm.

5. The process according to embodiment 1, wherein the organic extractant used in stage
g), is preferably DEHPA diluted to 10% by volume in kerosene.

Another embodiment of the present invention refers to:

6. A reactor for leaching lithium and potassium from clays from salt flats, comprising:

a plate-shaped stainless steel electrode constituting the structural element (i); the structural element (i) is introduced into a first subinterior grid box to form the structural element (ii); the structural element (ii) is introduced into a bag-shaped membrane that is permeable to Li+ and K+ cations to form the structural element (iii); the structural element (iii) is introduced into a second inner grid box to form the structural element (iv); the structural element (iv) is placed between two titanium electrodes that have the shape of plates, so that the major surface areas of the structural element (iv) are located between both plates, to form the structural element (v); the structural element (v) is then introduced in the middle of an outer box to form the leaching reactor.

7. The leaching reactor according to embodiment 6, which further comprises electrical conduction rails that are connected to each of the three electrodes of the reactor, and that allow said electrodes to be energized by applying an electric current to them.

8. The leaching reactor according to embodiment 6, which further comprises trays for the collection of waste located on the sides of each of the two major surface areas of the outer box.

9. The leaching reactor according to embodiment 6, which further comprises a lid or cover to avoid possible contamination.

10. The leaching reactor according to embodiment 6, wherein the grid boxes and the outer box are PVC or fiberglass.

Another additional embodiment of the present invention refers to:

11. A system for leaching and concentrating lithium and potassium from clays from salt flats, comprising:
(a) means for mixing the clays with pure water and sieving to remove stones and large particles, consisting in a screen or sieving machine;
(b) means for turbulently stirring the fluid or pulp resulting from (a), to release small particles consisting of a blender of blades;
(c) means for pouring a portion of the fluid obtained in (b), into the protonic section of a leaching reactor, and adding pure water into the alkaline section of the reactor in a 2:1 ratio by volume;
(d) means to perform a leaching process consisting of the leaching reactor of (c);
(e) means for removal of the wet agglomerates resulting from the protonic section and means for refilling the protonic section with a volume equivalent to the removed volume of wet agglomerates, to replenish the exhausted and removed clays from the reactor;
(f) means to repeat the operation of (e), until the complete consumption of the fluid or pulp of (b), to obtain an accumulated aqueous leached liquor in the alkaline section of the reactor;
(g) means of extraction for subjecting the leached liquor obtained in (f), to at least one solvent extraction process comprising turbulently mixing the liquor obtained in (f) as the aqueous phase with an organic extractant as the organic phase, in a 1:1 ratio by volume;
(h) means for separating the organic phase of the mixture obtained in (g) and means for mixing said organic phase with an aqueous solution with hydrochloric acid in a 3:1 ratio, respectively, to obtain a liquor with high concentration of lithium and potassium;
(i) means to recirculate the depleted aqueous liquors from (h) to the extraction process of (g) to enrich them of lithium and potassium and be fed back to the extraction and stripping process;
(j) means for conveying the lithium and potassium concentrated liquor obtained in (h) to precipitation media, wherein sodium phosphate is added to the concentrated liquor obtained in (h) to obtain precipitated lithium phosphate;
(k) means for drying wherein the remaining liquor from (j) is subjected to the drying process to obtain potassium hydroxide.

6. A system for leaching and concentrating lithium and potassium from clays from salt flats, comprising:
(a) means for mixing the clays with pure water and sieving to remove stones and large particles, consisting in a screen or sieving machine;
(b) means for turbulently stirring the fluid or pulp resulting from (a), to release small particles consisting of a blender of blades;
(c) means for pouring a portion of the fluid obtained in (b), into the protonic section of a leaching reactor, and adding pure water into the alkaline section of the reactor in a 2:1 ratio by volume;
(d) means to perform a leaching process consisting of the leaching reactor of (c);
(e) means for removal of the wet agglomerates resulting from the protonic section and means for refilling the protonic section with a volume equivalent to the removed volume of wet agglomerates, to replenish the exhausted and removed clays from the reactor;
(f) means to repeat the operation of (e), until the complete consumption of the fluid or pulp of (b), to obtain an accumulated aqueous leached liquor in the alkaline section of the reactor;
(g) means of extraction for subjecting the leached liquor obtained in (f), to at least one solvent extraction process comprising turbulently mixing the liquor obtained in (f) as the aqueous phase with an organic extractant as the organic phase, in a 1:1 ratio by volume;
(h) means for separating the organic phase of the mixture obtained in (g) and means for mixing said organic phase with an aqueous solution with hydrochloric acid in a 3:1 ratio, respectively, to obtain a liquor with high concentration of lithium and potassium;
(i) means to recirculate the depleted aqueous liquors from (h) to the extraction process of (g) to enrich them of lithium and potassium and be fed back to the extraction and stripping process;
(j) means for conveying the lithium and potassium concentrated liquor obtained in (h) to precipitation media, wherein sodium phosphate is added to the concentrated liquor obtained in (h) to obtain precipitated lithium phosphate;
(k) means for drying wherein the remaining liquor from (j) is subjected to the drying process to obtain potassium hydroxide.

“Means” in the present invention is to be understood as any device, apparatus, machinery, etc., commonly known and used in the art which permits to carry out the function described in the process. Among the means known and widely used in the art are, without limitation: mixers, reactors, silos, conveyor belts, piping, pumps, screens, sifters, reaction reactors, power sources, separation towers, distillation towers, filtration towers, containers, mills, ovens, reactors and/or extraction towers, evaporative drying units, among others.

### EXAMPLES OF EMBODIMENT

In order to exemplify and illustrate the present invention, the following practical examples made at laboratory scale are detailed below, however, they should not be considered as limiting of the present invention.

### Practical Example 1

a) 10 kg of clays (called sample A for this study) were weighed, which were mixed with 15 liters of tap water and then sieved by a mesh of #5 (US standard sieve) to remove stones and large particles. The resulting pulp was then turbulently stirred by a blades mixer to release all the small particles. It is worth mentioning that these clays contained a Li concentration of 259 mg/kg and a potassium concentration of 51,000 mg/kg, so the 10 kg of clay would contain approximately 2,590 mg of lithium and 510,000 mg of potassium.
b) 5 liters of the pulp described in the previous point were taken and poured into the protonic section of the reactor and 5 liters of tap water were added to the alkaline section of the reactor. Once leaching started, it remained active for 20 minutes until it was observed that the electrical charge of the clay particles was neutralized and that they clustered together. When observing these agglomerates approximately half a liter of wet agglomerates was removed from the protonic section and half a liter of fresh pulp was recharged to replace the exhausted and extracted clays from the reactor. These operations were repeated several times for about a day and a half, until the pulp described in the first subsection was finished. It is worth mentioning that of the 20 liters of water added to the reactor, 14 liters of alkaline liqueur were recovered, and the rest was separated by moisturizing the depleted clays. The aqueous liquor accumulated in the alkaline section of the reactor reached a pH of 13, an electrical conductivity of 45 MS/cm, approximately 150 mg/L of Li and 24, 100 mg/L of K.
c) Doing a mass balance of the lithium fed into the 10 kg of clays and lithium fed 2,590 mg of lithium and 510,000 mg of potassium, while 2,100 mg of lithium and 337,400 mg of potassium were recovered in the 14 liters of leaching liquor. These results represent a recovery of lithium and potassium metals of 81% and 66%, respectively.
d) The leachate liqueur subsequently went to a solvent extraction stage described in this point. Single-stage extractions were carried out at room temperature (˜ 20° C.) and stirring for 3 min, also measuring the separation time between phases by visual inspection. A ratio of volumes 1:1 between aqueous and organic phase was used, adding 14 liters of each one. The organic phase consisted of DEHPA extractant diluted to 10% by volume in kerosene (diaphanous oil). In the stripping stage, 5 liters of solution with HCl were used again.
e) By performing a new mass balance in the solvent extraction and stripping stage, 14 liters of lixiviant liquor were processed with 2,100 mg of lithium and 337,400 mg of potassium and at the end of both processes 5 liters of stripping liquor were obtained with 1,827 mg of lithium and 253,050 mg of potassium, representing recoveries of 87% lithium and 75% potassium, in two stages of extraction and stripping. It is worth mentioning that the exhausted aqueous liquors are recirculated back to the extraction process to enrich them with lithium and potassium and to be fed again to the extraction and stripping process.
f) The liqueur concentrated in lithium and potassium is then passed to a precipitation stage to obtain lithium phosphate, adding sodium phosphate. Here, it is important to remember that the solubility of lithium phosphate in water is 0.39 g/L at 18° C., so a fraction of these compounds will always remain unprecipitated. By adding 20% in excess of the required stoichiometrically sodium triphosphate (17.26 g Na₃PO₄), 9.5 g of lithium phosphate (Li₃PO₄) could be precipitated, which corresponds to a recovery of 90.7% of lithium at this stage.

### Practical Example 2

Following a methodology similar to that described in the Practical Example 1 described above, 5 kg of clays (called sample B) were weighed which are poorer in Li and K than clays in sample A, to which were added 7.5 liters of water, and the pulp was prepared separating the large particles and stirring it intensely. In this case, clays contained 170 mg/kg Li and 11000 mg/kg K, so 5 kg of clay retained 850 mg lithium and 55,000 mg potassium.

Then, all the pulp prepared initially (5 kg of clays+7.5 L of water) was processed in the leaching reactor and 7 liters of alkaline leaching liquor were recovered; the rest of water was left with the depleted clays. In this case the concentrated liquor reached a pH of 13.2 and an electrical conductivity of 46 mS/cm, containing approximately 95 mg/L of Li and 6,600 mg/L of K. With these concentrations the concentrate liquor contains 665 mg of lithium and 46,200 mg of potassium. With these results the recovery is 78.2% of Li and 84% of potassium in the leaching stage.

When processing this concentrate liquor from leaching, now by solvent extraction and stripping, the resulting 1.5 liters of liquor contained 590 mg of lithium and 34,100 mg of potassium, obtaining 88% and 73.8% of potassium, respectively in the latter process. Phosphoric acid and then perchloric acid were also added to this resulting liquor to verify the precipitation of lithium phosphate.

The figures described below show some results obtained through the Practical Example 1, and are proof of the effectiveness of the method described herein.

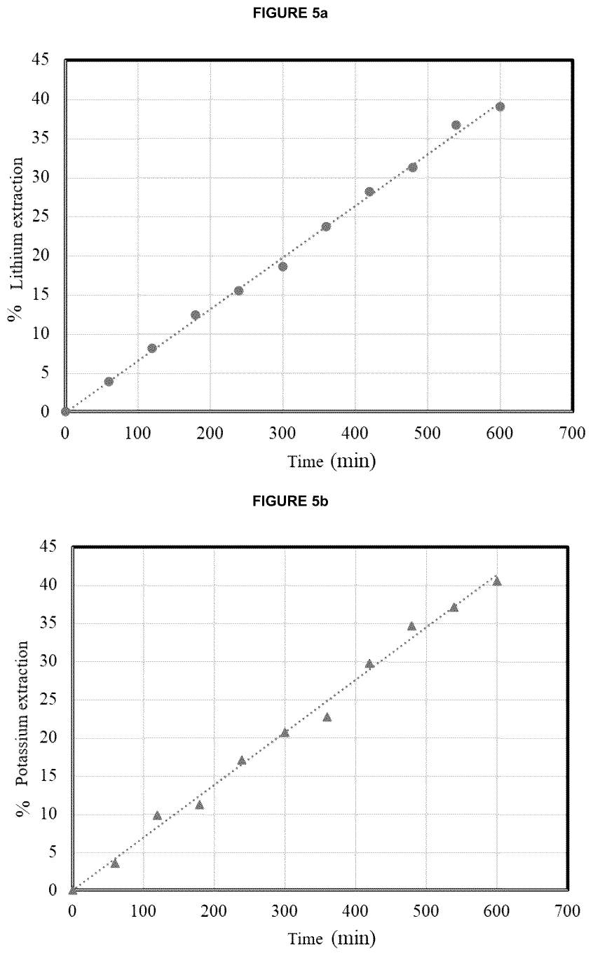

FIGS. 5a and 5b show leaching kinetics in the first 10 hours of extraction from the addition of 5 kg of clay in the protonic zone of lithium (FIG. 5a) and potassium (FIG. 5b), i.e. the percentage of lithium and potassium extraction is illustrated, from the start of the leaching test, loading 5 kg of clays in the leaching reactor; it is evident that there is a linear kinetics of recovery of the metals of interest, depending on the time.

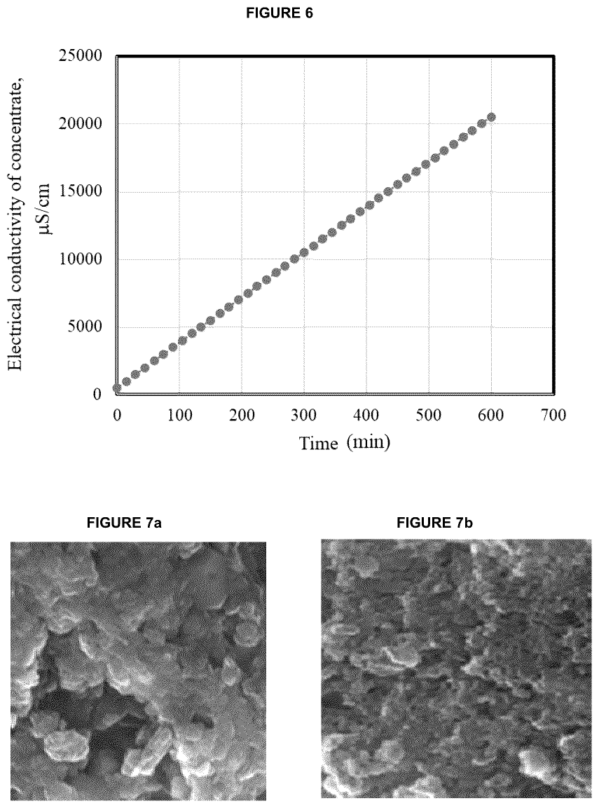

FIG. 6 shows the growth of the electrical conductivity of the alkaline or concentrate solution, which is due to the fact that lithium and potassium are concentrating in the alkaline zone of the reactor.

FIGS. 7a and 7b show images of the clays before (FIG. 7a) and after (FIG. 7b) leaching; as can be seen, the latter reveal evidence of acid attack of the protonic zone of the reactor.

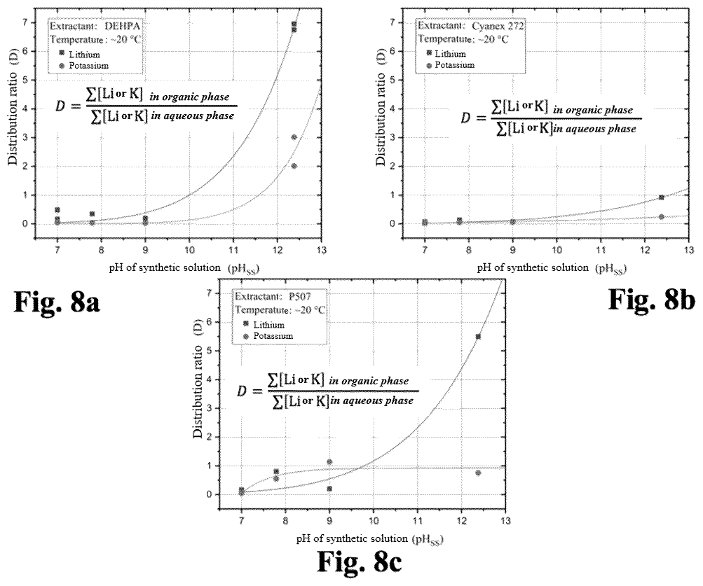

FIGS. 8a, 8b, and 8c present plots of the distribution coefficients of lithium, or potassium, between the organic phase and the aqueous phase, and indicate that at alkaline pH both metals are concentrated in the organic phase, suggesting that the solvent extraction subprocess is effective in removing these metals from the dilute aqueous phase. Various extractants were used to obtain these diagrams; in FIG. 8a DEHPA was used as extractant; in FIG. 8b CYANEX 272 was used as extractant; and in FIG. 8c P507 was used as extractant.

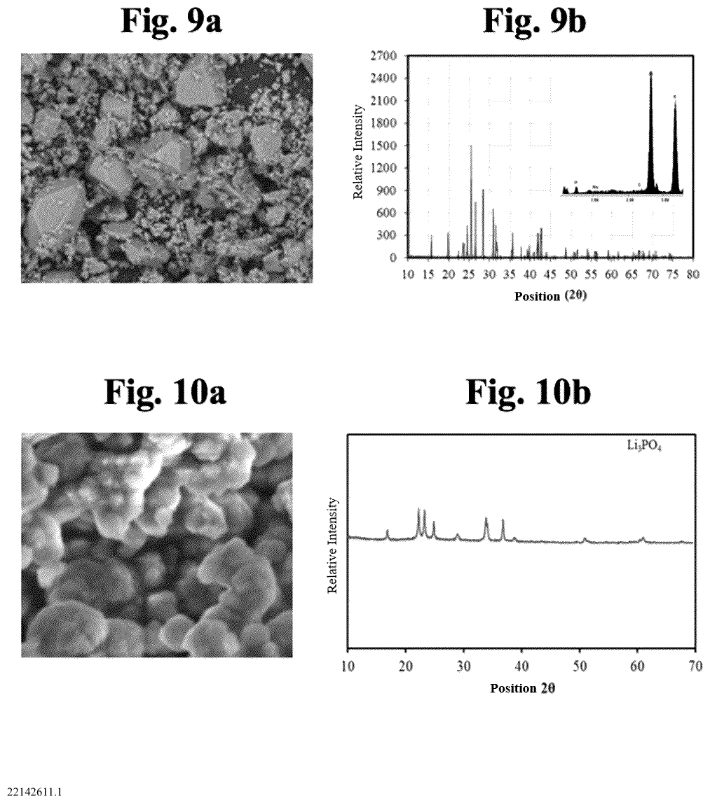

FIGS. 9a, 9b, 10a and 10b present various micrographs and X-ray diffractograms of lithium phosphate and potassium perchlorate crystals and are evidence of the presence of lithium and potassium in the leach liquors upon employing the process of the present invention. In particular, FIG. 9a shows a micrograph of KCIO₄ crystals. FIG. 9b shows an X-ray diffraction spectrum and an Energy Dispersive X-ray Spectroscopy (EDS) spectrum of KCIO₄. FIG. 10a shows a micrograph of Li₃PO₄ crystals. Finally, FIG. 10b shows an X-ray diffraction spectrum of Li₃PO₄.

The present invention has been sufficiently described so that a person of average skill in the art could reproduce and obtain the results mentioned in the present description, which, moreover, has been provided by way of explanation and illustration of the present invention and is not to be construed as limiting the scope of the appended claims and any equivalents thereof. However, any person skilled in the field of the art that falls within the scope of the present invention may be able to make modifications and substitutions without departing from the spirit of the invention as defined in the appended claims.

1. A process for leaching and concentrating lithium and potassium from clays from salt flats, comprising the stages of:
a) mixing the clays with pure water and sieving to remove stones and large particles;
b) turbulently stirring with a blade mixer the fluid or pulp resulting from stage a) to release small particles;
c) pouring a portion of the fluid obtained in stage b) into the protonic section of a leaching reactor and adding pure water into the alkaline section of the reactor in a 2:1 ratio by volume;
d) initiating the leaching process at the reactor;
e) removing the wet agglomerates resulting from the protonic section and recharge the protonic section with a volume equivalent to the removed volume of wet agglomerates, in order to replace the exhausted clays extracted from the reactor;
f) repeating the operation of stage e), until full consumption of the fluid or pulp of stage b), to obtain an aqueous leachate liquor accumulated in the alkaline section of the reactor;
g) subjecting the leachate liqueur obtained in stage f) to at least one solvent extraction process comprising turbulently mixing the liqueur obtained in stage f) as an aqueous phase with an organic extractant as an organic phase, in a 1:1 ratio by volume;
h) separating the organic phase from the mixture obtained in stage g) and mixing the organic phase with an aqueous solution with hydrochloric acid in a ratio of 3:1, respectively, to obtain a liqueur with a high concentration of lithium and potassium;
i) exhausted aqueous liqueurs from stage h) are recirculated back to the extraction process from stage g) to enrich them with lithium and potassium and be fed back to the extraction and stripping process;
j) liquor concentrated in lithium and potassium obtained in stage h) is passed to a precipitation stage, wherein the precipitation stage consists of adding sodium phosphate to the concentrated liqueur obtained in stage h) to obtain precipitated lithium phosphate;
k) the remaining liquor of stage j) is subjected to a drying process to obtain potassium hydroxide.

2. The process according to claim 1, wherein stage d) is carried out for at least 30 minutes.

3. The process according to claim 1, wherein step f) is repeated for at least 36 hours.

4. The process according to claim 1, wherein the accumulated aqueous leachate liquor obtained in stage f), has a pH of at least 13 and an electrical conductivity of at least 45 mS/cm.

5. The process according to claim 1, wherein the organic extractant used in stage g), is preferably DEHPA diluted to 10% by volume in kerosene.

6. A reactor for leaching lithium and potassium from clays from salt flats, comprising:
a plate-shaped stainless steel electrode constituting the structural element (i); the structural element (i) is introduced into a first subinterior grid box to form the structural element (ii); the structural element (ii) is introduced into a bag-shaped membrane that is permeable to Li⁺ and K⁺ cations to form the structural element (iii); the structural element (iii) is introduced into a second inner grid box to form the structural element (iv); the structural element (iv) is placed between two titanium electrodes that have the shape of plates, so that the major surface areas of the structural element (iv) are located between both plates, to form the structural element (v); the structural element (v) is then introduced in the middle of an outer box to form the leaching reactor.

7. The leaching reactor according to claim 6, which further comprises electrical conduction rails that are connected to each of the three electrodes of the reactor, and that allow said electrodes to be energized by applying an electric current to them.

8. The leaching reactor according to claim 6, which further comprises trays for the collection of waste located on the sides of each of the two major surface areas of the outer box.

9. The leaching reactor according to claim 6, which further comprises a lid or cover to avoid possible contamination.

10. The leaching reactor according to claim 6, wherein the grid boxes and the outer box are PVC or fiberglass.

11. A system for leaching and concentrating lithium and potassium from clays from salt flats, comprising:
(a) means for mixing the clays with pure water and sieving to remove stones and large particles, consisting in a screen or sieving machine;
(b) means for turbulently stirring the fluid or pulp resulting from (a), to release small particles consisting of a blade mixer;
(c) means for pouring a portion of the fluid obtained in (b), into the protonic section of a leaching reactor, and adding pure water into the alkaline section of the reactor in a 2:1 ratio by volume;
(d) means to perform a leaching process consisting of the leaching reactor of (c);
(e) means for removal of the wet agglomerates resulting from the protonic section and means for refilling the protonic section with a volume equivalent to the removed volume of wet agglomerates, to replenish the exhausted and removed clays from the reactor;
(f) means to repeat the operation of (e), until the complete consumption of the fluid or pulp of (b), to obtain an accumulated aqueous leached liquor in the alkaline section of the reactor;
(g) means of extraction for subjecting the leached liquor obtained in (f), to at least one solvent extraction process comprising turbulently mixing the liquor obtained in (f) as the aqueous phase with an organic extractant as the organic phase, in a 1:1 ratio by volume;
(h) means for separating the organic phase of the mixture obtained in (g) and means for mixing said organic phase with an aqueous solution with hydrochloric acid in a 3:1 ratio, respectively, to obtain a liquor with high concentration of lithium and potassium;
(i) means to recirculate the depleted aqueous liquors from (h) to the extraction process of (g) to enrich them of lithium and potassium and be fed back to the extraction and stripping process;
(j) means for conveying the lithium and potassium concentrated liquor obtained in (h) to precipitation media, wherein sodium phosphate is added to the concentrated liquor obtained in (h) to obtain precipitated lithium phosphate;
(k) means for drying wherein the remaining liquor from (j) is subjected to the drying process to obtain potassium hydroxide.
